(19) United States
(12) Patent Application Publication
(10) Pub. No.: US 2025/0159346 A1
(43) Pub. Date: May 15, 2025

(54) CONTROL APPARATUS, OPTICAL APPARATUS, AND CONTROL METHOD

(71) Applicant: CANON KABUSHIKI KAISHA, Tokyo (JP)

(72) Inventor: DAISUKE HIRAI, Tochigi (JP)

(21) Appl. No.: 18/943,074

(22) Filed: Nov. 11, 2024

(30) Foreign Application Priority Data
Nov. 13, 2023 (JP) 2023-192682

(51) Int. Cl. H04N 23/68

(52) U.S. Cl. CPC H04N 23/6811; H04N 23/6812; H04N 23/687

(57) ABSTRACT

A control apparatus includes a processor configured to acquire an object position and an object speed from an image generated using an output of an image sensor that is configured to photoelectrically convert an object image formed by an optical system including an optical element, perform a first control that moves at least one of the optical element and the image sensor based on the object speed and a detection result of a motion of an optical apparatus including at least one of the optical system and the image sensor by panning-shot the optical apparatus, and perform a second control that moves the at least one of the optical element and the image sensor based on the object position before the imaging so that the object image moves to a predetermined position or direction on the image sensor.

### BACKGROUND

### Technical Field

The present disclosure relates to panning-shot (or follow-shot) assisting control for an optical apparatus, such as a digital camera.

### Description of Related Art

In panning-shot of a moving object using a camera, a shutter speed is generally reduced for dynamic expression of a moving object. However, the reduced shutter speed is likely to cause image blur. Japanese Patent Laid-Open No. 2007-139952 discloses an object tracking method that calculates an object speed from a difference between an object moving speed on an image sensor and a panning-shot speed at which the user moves the image pickup apparatus, and decenters an optical system to correct an error between the object speed and the panning-shot speed during imaging of the panning-shot. Thereby, panning-shot can be achieved while an object position within an imaging screen (captured image) is maintained.

Image stabilizing methods that optically reduce image blur are classified into a lens shift method (optical image stabilization: OIS) configured to move a correction lens (shift lens) relative to the optical axis, and an in-camera sensor shift method (in-body image stabilization: IBIS) configured to move the image sensor relative to the optical axis. Japanese Patent No. 6410431 discloses a camera system that improves image stabilizing performance by utilizes both OIS and IBIS at a ratio that effectively uses their movable ranges.

### SUMMARY

A control apparatus according to one aspect of the present disclosure includes a processor configured to acquire an object position and an object speed from an image generated using an output of an image sensor that is configured to photoelectrically convert an object image formed by an optical system including an optical element, perform a first control that moves at least one of the optical element and the image sensor based on the object speed and a detection result of a motion of an optical apparatus including at least one of the optical system and the image sensor by panning the optical apparatus, and perform a second control that moves the at least one of the optical element and the image sensor based on the object position before the imaging so that the object image moves to a predetermined position or direction on the image sensor. An optical system and a control method corresponding to the above control apparatus also constitute another aspect of the present disclosure.

Further features of various embodiments of the disclosure will become apparent from the following description of embodiments with reference to the attached drawings.

### BRIEF DESCRIPTION OF THE DRAWINGS

FIG. 1 is a block diagram illustrating the configuration of an imaging system according to one or more aspects of the present disclosure.

FIG. 2 is a block diagram illustrating the configuration of an image stabilizing system according to one or more aspects of the present disclosure.

FIGS. 3A, 3B, and 3C illustrate panning-shot.

FIGS. 4A, 4B, and 4C illustrate a calculation method of an object vector according to one or more aspects of the present disclosure.

FIG. 5 illustrates an object angular velocity, panning-shot angular velocity, and motion (shift amount) in OIS during panning-shot according to one or more aspects of the present disclosure.

FIGS. 6A and 6B illustrate successful and unsuccessful images by panning-shot according to one or more aspects of the present disclosure.

FIGS. 7A and 7B illustrate composition adjusting control before panning-shot according to one or more aspects of the present disclosure.

FIG. 8 is a flowchart illustrating panning-shot assisting processing according to one or more aspects of the present disclosure.

FIG. 9 illustrates an object angular velocity, panning-shot angular velocity, and motions (shift amounts) in OIS and IBIS during composition adjusting control and panning-shot.

FIG. 10 illustrates an object angular velocity, panning-shot angular velocity, and motions (shift amounts) in OIS and IBIS during composition adjusting control and panning-shot in a second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the present disclosure.

### First Embodiment

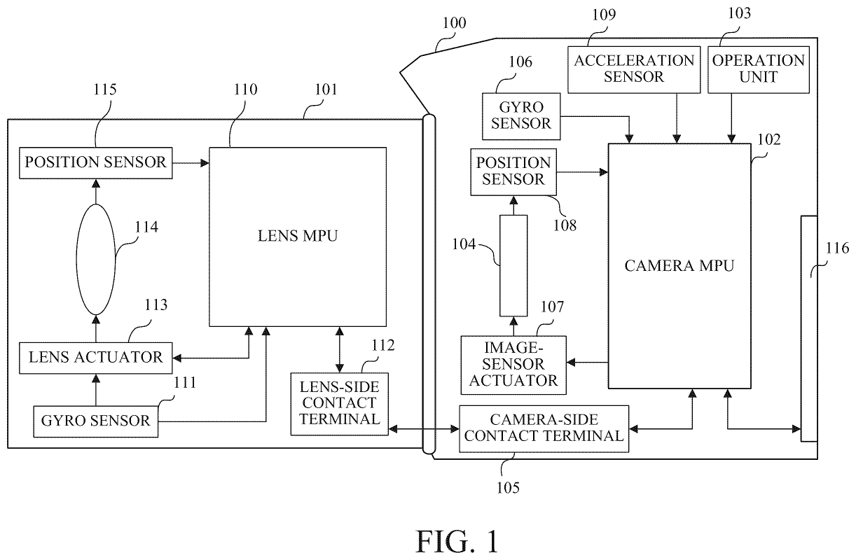

FIG. 1 illustrates the configuration of an imaging system according to a first embodiment. The camera system includes an interchangeable lens 101 as a lens apparatus, and an image pickup apparatus (referred to as the camera body hereinafter) 100 as an optical apparatus to which the interchangeable lens 101 is detachably and communicably connected.

The camera body 100 includes a camera MPU 102 as a computer, an operation unit 103, an image sensor 104, a camera-side contact terminal 105, a camera-side gyro sensor 106, an acceleration sensor 109, and a rear display 116.

The camera MPU 102 is a controller configured to control the entire camera system that consists of the camera body 100 and the interchangeable lens 101, and controls various operations such as auto-exposure (AE), autofocus (AF), and imaging according to an input from the operation unit 103, which will be described later. The camera MPU 102 communicates various commands and information with the lens MPU 110 via the camera-side contact terminal 105 and a lens-side contact terminal 112 provided on the interchangeable lens 101. The camera-side contact terminal 105 and the lens-side contact terminal 112 include a power terminal for supplying power from the camera body 100 to the interchangeable lens 101.

The operation unit 103 includes a mode selection dial operable by the user (photographer) to select various imaging modes, a release button operable by the user to instruct an imaging preparation operation and an imaging operation, and the like. By operating the mode selection dial, an imaging mode such as a still image capturing mode, a moving image capturing mode, and a panning-shot assisting mode described later can be selected. In a case where the release button is half-pressed, a first switch (Sw1) is turned on, and in a case where it is fully pressed, a second switch (Sw2) is turned on. AE and AF are performed as an imaging preparation operation when Sw1 is turned on. When Sw2 is turned on, the AE setting is finalized, AF is stopped, and an instruction to start imaging (exposure) is issued. When an exposure starting instruction is given, the camera MPU 102 first turns on Sw2-1 as an exposure preparation signal, and then turns on Sw2-2 as an exposure instruction signal that instructs the start of actual exposure a predetermined time after the instruction to start the imaging operation is issued. Sw2-1 and Sw2-2 are turned off when the set exposure time has elapsed and imaging has ended. The camera MPU 102 notifies the lens MPU 110 of the turning-on and turning-off statuses of Sw1, Sw2-1, and Sw2-2 through communication.

The image sensor 104 includes a photoelectric conversion element such as a CCD sensor or a CMOS sensor, and generates an imaging signal by photoelectrically converting (capturing) an object image formed by an imaging optical system (described later). The camera MPU 102 generates a captured image (image data) using the imaging signal from the image sensor 104.

The camera-side gyro sensor 106 is a shake sensor configured to detect angular shake (camera shake) applied to the camera body 100 due to handheld shake or the like, and outputs a camera-shake detecting signal as an angular velocity signal. The camera MPU 102 controls the driving of an image sensor actuator (driving unit) 107 based on the camera-shake detecting signal, etc., and moves (shifts) the image sensor 104 in a direction orthogonal to the optical axis of the imaging optical system. At this time, the camera MPU 102 performs feedback control of the image sensor actuator 107 so that the position of the image sensor 104 detected by an image-sensor position detector 108 (a moving amount from a position on the optical axis that is a shift center) approaches the target position. Thereby, image stabilization using a sensor shift method by shifting the image sensor 104 (IBIS) is performed.

The camera MPU 102 also recognizes an object, separates the object from the background, performs calculations to acquire a moving direction and moving speed of the object, etc., based on the image data from the image sensor 104 and the lens information received from the lens MPU 110.

The acceleration sensor 109 is used to detect the attitude of the camera body 100 and to detect shift shake that is difficult to detect with the camera-side gyro sensor 106 described above.

The rear display 116, which serves as a display unit, displays image data as an image or video obtained by the camera MPU 102 through the image sensor 104. In the following description, imaging (exposure) refers to imaging for recording to obtain a still or moving image for recording. Before imaging (before exposure), the user can observe the image displayed on the rear display 116 as a viewfinder image (live-view image). After imaging (after exposure), the image data can be displayed on the rear display 116 as a still or moving image for recording.

The interchangeable lens 101 includes an unillustrated imaging optical system, a lens MPU 110 as a computer, a lens-side contact terminal 112, and a lens-side gyro sensor 111. The lens-side gyro sensor 111 is a shake sensor configured to detect angular shake (lens shake) of the interchangeable lens 101 and outputs a lens-shake detecting signal as an angular velocity signal.

The lens MPU 110 controls the driving of the lens actuator (driving unit) 113 based on the lens-shake detecting signal and an OIS correction ratio (described later), and thereby moves (shifts) a correction lens (shift lens) 114, which is an optical element that is part of the imaging optical system, in a direction orthogonal to the optical axis of the imaging optical system. At this time, the lens MPU 110 performs feedback control of the lens actuator 113 so that the position of the correction lens 114 detected by the lens position sensor 115 (a moving amount from the position on the optical axis that is the shift center) approaches the target position. Thereby, image stabilization (OIS) is performed by shifting the correction lens 114.

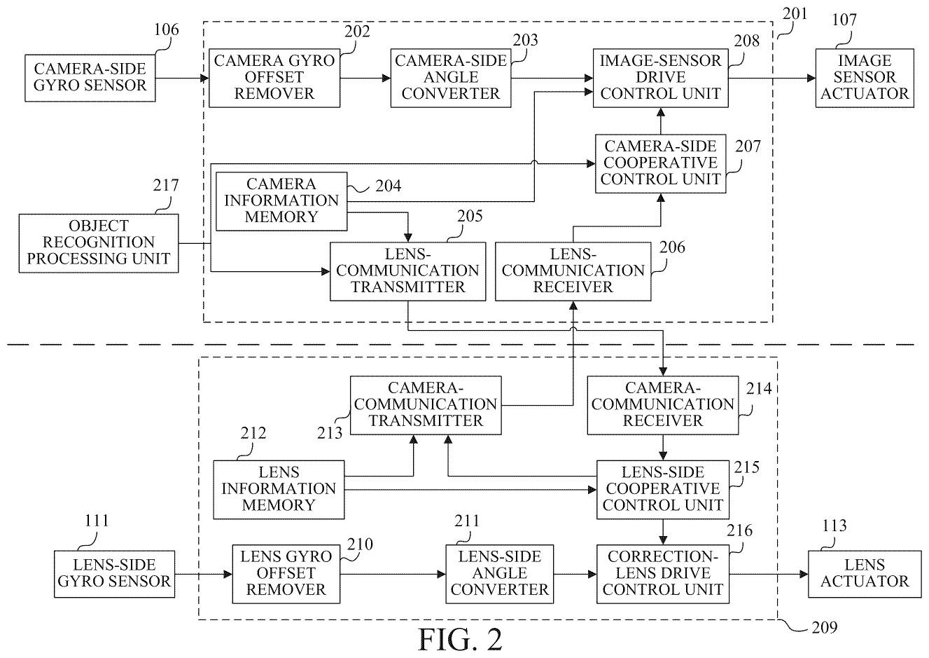

FIG. 2 illustrates the configuration of an image stabilizing system in the camera system according to this embodiment. The image stabilizing system includes a camera image stabilizer 201 provided on the camera body 100 side and a lens image stabilizer 209 provided on the interchangeable lens 101 side. The camera image stabilizer 201 is part of the camera MPU 102, and the lens image stabilizer 209 is part of the lens MPU 110.

A camera gyro offset remover 202 removes an offset component from the camera-shake detecting signal (angular velocity signal) output from the camera-side gyro sensor 106 mounted on the camera body 100. A camera-side angle converter 203 converts the angular velocity signal output from the camera gyro offset remover 202 into an angular signal. A camera information memory 204 stores camera information such as a drivable (or shiftable) amount of IBIS and the size of the image sensor 104. The camera information is used for driving control of the IBIS and is transmitted from a lens-communication transmitter 205 to the lens MPU 110. The lens-communication transmitter 205 also transmits to the lens MPU 110 object information (e.g., object position, object speed, etc.) obtained from an object recognition processing unit 217 provided in the camera MPU 102 separately from the image stabilizing system.

A lens-communication receiver 206 receives OIS information regarding image stabilization (information such as OIS correction ratio and OIS sensitivity indicating a relationship between the shift amount of the correction lens 114 and the image stabilizing amount) transmitted from the camera communication transmitter 213 of the interchangeable lens 101. The camera-side cooperative control unit 207 determines an image stabilizing amount to be conducted by IBIS based on the camera information read out of the camera information memory 204 and the OIS information received through the lens-communication receiver 206. An image-sensor drive control unit 208 generates a drive control signal for shifting the image sensor 104 in the IBIS based on the angular signal output from the camera-side angle converter 203 and the image stabilizing amount determined by the camera-side cooperative control unit 207.

In a case where the panning-shot assisting mode is set, the camera-side cooperative control unit 207 determines an adjustment shift amount of the image sensor 104 based on the object position indicated by the object information from the object recognition processing unit 217. The image-sensor drive control unit 208 generates a drive control signal for shifting the image sensor 104 by the adjustment shift amount.

The lens gyro offset remover 210 removes the offset component from the lens-shake detecting signal (angular velocity signal) output from the lens-side gyro sensor 111 mounted on the interchangeable lens 101. A lens-side angle converter 211 converts the angular velocity signal output from the lens gyro offset remover 210 into an angular signal. A camera-communication receiver 214 receives object information and information on the drive amount of the correction lens 114 transmitted from the lens-communication transmitter 205 of the camera body 100. The lens information memory 212 stores information on the OIS drivable amount and OIS sensitivity. The lens information memory 212 also stores IBIS sensitivity information indicating the relationship between the shift amount of the image sensor 104 and the image stabilizing amount.

The lens-side cooperative control unit 215 performs cooperative control of the OIS and IBIS based on the information read from the lens information memory 212 and the information received through the camera-communication receiver 214. At this time, the lens-side cooperative control unit 215 calculates a correction ratio, which is a ratio of the image stabilizing amount corrected by the OIS and the IBIS (ratio regarding the control of the OIS and the IBIS). A correction-lens drive control unit 216 generates a drive control signal for shifting the correction lens 114 in the OIS, based on the angular signal from the lens-side angle converter 211. In a case where the panning-shot assisting mode is set in the camera body 100, the correction-lens drive control unit 216 generates a drive control signal for shifting the correction lens 114 to perform object tracking control (first control) based on the object information received via the camera-communication receiver 214.

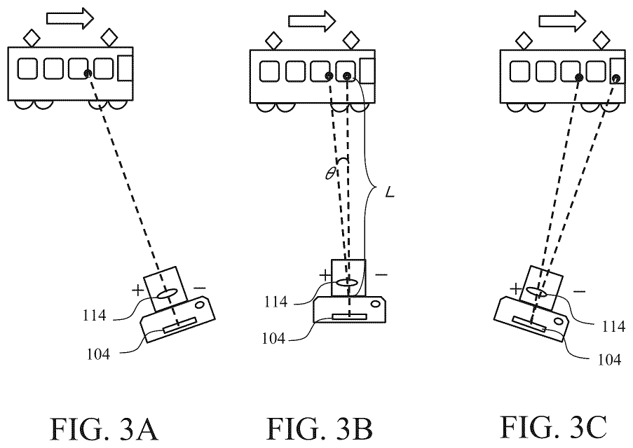

A description will now be given of panning-shot. FIGS. 3A, 3B, and 3C illustrate the motions of an object and the camera (system) in time series in panning-shot of the object (a train) passing in front of the photographer. In panning-shot, the camera is moved (panned) to match the object moving speed even during the exposure period, and a captured image is obtained in which the object motion stops and the background flows. As illustrated in FIGS. 3A, 3B, and 3C, even if the photographer attempts to pan the camera to match the object motion, a difference may actually occur between the speed at which the camera is panned (panning-shot speed) and the object moving speed (object speed). There is a correlation between the fluctuation in the object speed and the fluctuation in the output of the shake sensor provided to the camera.

As illustrated in FIG. 3B, the following equation holds:

$$D = β L πθ / 180 \qquad ( 1 )$$

where θ [deg] is an angular displacement of the camera motion, L is an object distance, β is an imaging magnification, and D is a shake displacement of the object image.

Therefore, the following equation holds:

$$Va = β L πω a / 180 \qquad ( 2 )$$

where Va is an object speed, and ωa is a panning-shot angular velocity of the camera detected by the shake sensor (detection result of motion).

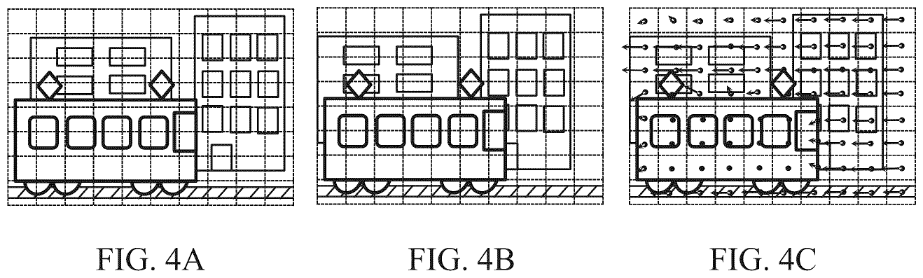

FIGS. 4A and 4B illustrate an object image formed on the image sensor 104. When the object recognition processing unit 217 processes the image data obtained by photoelectrically converting the object image using the image sensor 104, the object and background in the image data can be separated, and object information indicating the size, type (car, train, bird, person, etc.), position, and moving speed of the object can be obtained.

FIGS. 4A and 4B illustrate object images formed on the image sensor 104 at a first timing in panning-shot and a second timing that is later than the first timing by a predetermined sampling rate, respectively. FIG. 4C illustrates motion vector data obtained as a result of performing comparison processing for each area divided into a grid shape for the object images illustrated in FIGS. 4A and 4B. Due to the panning-shot, the position of the object (the train) in the captured image does not change much in FIG. 4C, and a small value is output as the motion vector data. On the other hand, the background (buildings, etc.) moves at a speed equivalent to the object speed, so a large value of motion vector data is obtained. An object speed Va is calculated from a shift amount between corresponding pixels at specified sampling rates.

By subtracting an angular speed ωa from an output ω of the shake sensor during exposure (imaging) of panning-shot, an angular speed ωo for good panning-shot, that is, for accurate tracking of the moving object, can be calculated as expressed in the following equation (3):

$$ω o = ω - ω a = ω - 180 Va / ( β L π ) \qquad ( 3 )$$

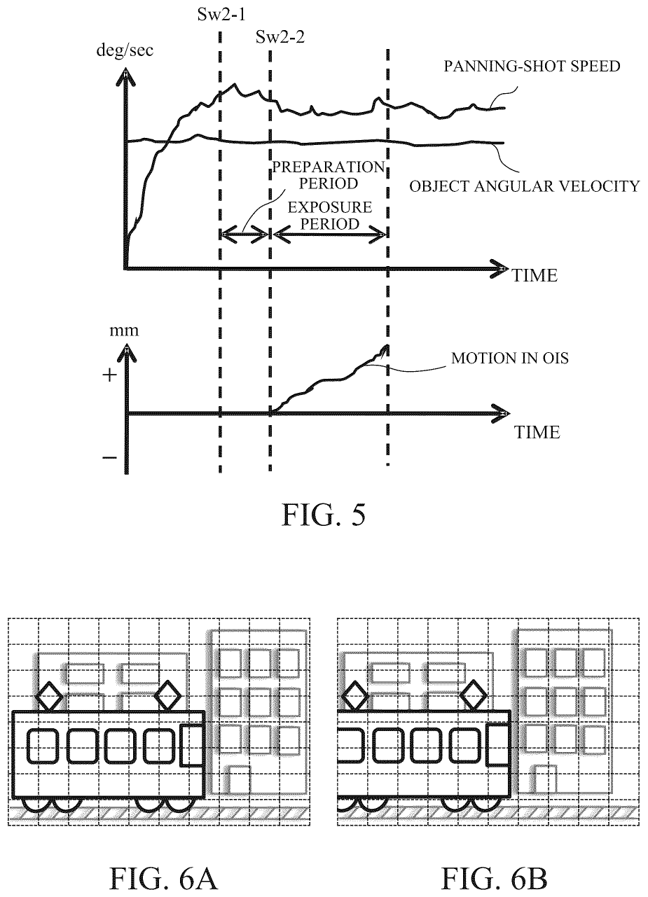

A top diagram in FIG. 5 illustrates an object speed during panning-shot illustrated in FIGS. 3A, 3B, and 3C, and a panning-shot speed detected through the lens-side gyro sensor 111, each converted into an angular speed [deg/sec]. A bottom diagram illustrates a shift amount of the correction lens 114. In a case where the camera is panned at a speed faster than the object speed as illustrated in FIGS. 3A, 3B, and 3C for panning-shot, in order to cancel the blur of the object image during exposure, the camera MPU 102 notifies the lens MPU 110 of the object speed during a preparation period as the first period when the exposure preparation signal (Sw2-1) is turned on. Then, during the exposure period as the second period that starts when the exposure instruction signal (Sw2-2) is turned on, the correction lens 114 (OIS) is shifted in a + direction illustrated in the bottom diagram of FIG. 5 at a speed to obtain the angular velocity ωo.

Thus, good panning-shot in which image blur is reduced during panning-shot can be achieved by shifting the correction lens 114 so as to reduce or eliminate a difference between the object speed and the panning-shot speed and by tracking the object.

However, while the composition desired by the photographer is one in which the entire train as an object fits within the captured image as illustrated in FIG. 6A, but the captured image actually obtained by panning-shot (referred to as a panning-shot image hereinafter) does not include part of the train within the captured image as illustrated in FIG. 6B. In this case, panning-shot is unsuccessful. In the object tracking illustrated in FIG. 5, the position of the object image at the start of exposure is maintained, and thus if panning-shot is started with the composition illustrated in FIG. 6B, a panning-shot image with the composition illustrated in FIG. 6A cannot be obtained. Hence, in this embodiment, a composition adjusting control (second control) is performed as processing for adjusting the position of the object image in the imaging screen image (i.e., on the imaging surface of the image sensor 104), that is, the composition, just before exposure.

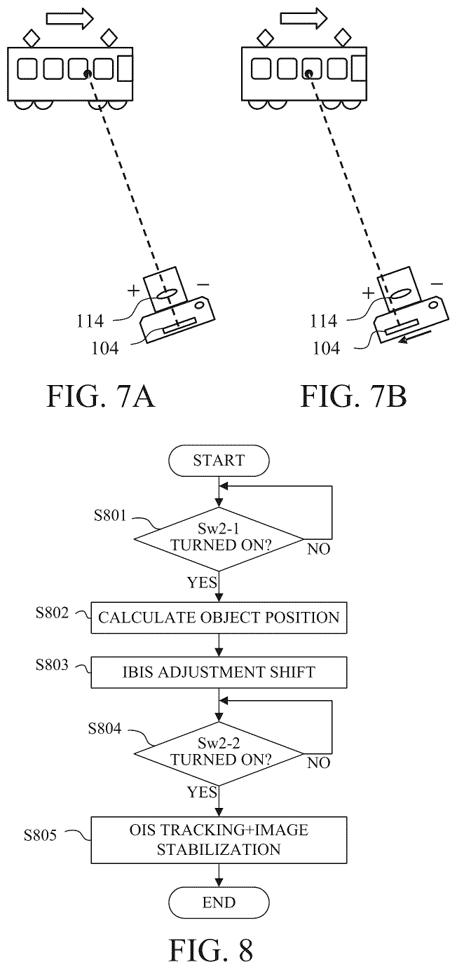

FIG. 7A illustrates the same state as FIG. 3A. FIG. 7B illustrates a composition adjustment in which the position of the object image in the imaging screen, that is, the composition, is adjusted by shifting the image sensor 104 before object tracking. The flowchart in FIG. 8 illustrates panning-shot assisting processing (control method) including the composition adjusting control and object tracking control, which is executed according to a program by the camera MPU 102 as a control apparatus for panning-shot. The camera MPU 102 functions as an acquiring unit and a control unit.

In step S801, when the photographer instructs the start of exposure and Sw2-1 is turned on (the preparation period starts before imaging), the camera MPU 102 causes the object recognition processing unit 217 to calculate the object position (the center of gravity of the object image in this embodiment) in step S802.

Next, in step S803, the camera MPU 102 causes the camera-side cooperative control unit 207 to calculate an adjustment shift amount for the IBIS based on the object position calculated in step S802 so that the position of the object image moves to the center position (predetermined position) of the imaging screen in the panning-shot direction. The IBIS is then shifted by this adjustment shift amount. Thereby, the composition adjustment is performed.

Thereafter, in step S804, Sw2-2 is turned on and exposure is started (the exposure period starts during imaging), and the camera MPU 102 causes the correction-lens drive control unit 216 to control the OIS for object tracking in step S805. At this time, the camera MPU 102 may perform control of the IBIS to correct image blur caused by handheld shake or the like, or may perform cooperative control of the OIS and IBIS. After the panning-shot exposure is thus completed, this flow ends.

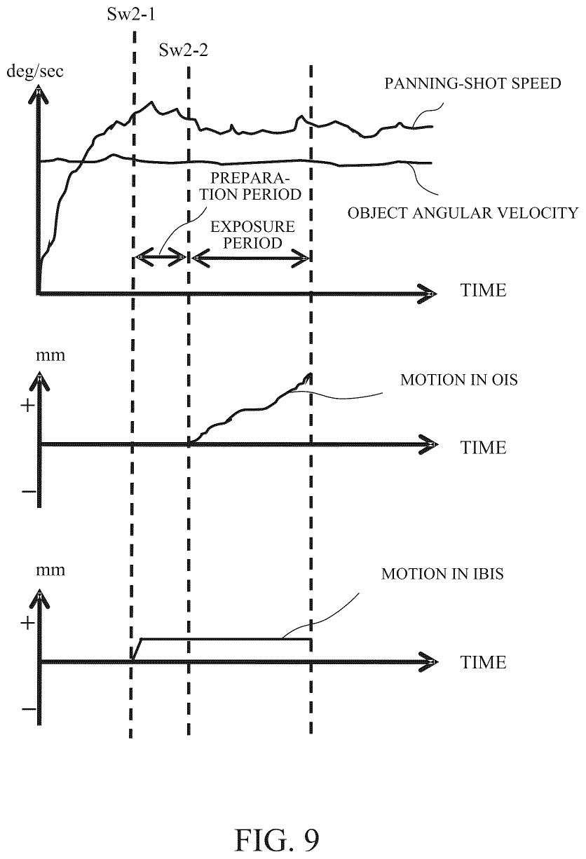

FIG. 9 adds shifting of the image sensor 104 (IBIS) in composition adjustment to FIG. 5. First, before exposure, that is, during the preparation period from when Sw2-1 is turned on to when exposure starts, the position of the object image within the imaging screen is adjusted by shifting the IBIS (one of the lens and the image sensor), and then the position of the object image is maintained (that is, the IBIS is stopped at the position after the composition adjustment).

Next, during the exposure period that starts when Sw2-2 is turned on, the OIS (the other of the lens and the image sensor) is shifted for object tracking. Thus, the position of the object image within the imaging screen can be adjusted while the drive amount of the OIS is secured for object tracking. As a result, a panning-shot image with a composition such as that illustrated in FIG. 6A is obtained.

The adjustment shift amount (including the shift direction) of the IBIS before exposure may be calculated by a method other than the calculation method described above. For example, the object type obtained from the object recognition processing unit 217 may be identified, and the adjustment shift amount may be calculated so as to approach a desired composition according to the identification result. The photographer may be prompted to input (instruct) a target position of the object image within the imaging screen, and the adjustment shift amount may be calculated so that the position of the object image moves to that target position. A captured image in which the object falls within the imaging angle of view may be previously registered, and the adjustment shift amount may be calculated so that the entire object falls within the imaging angle of view by identifying the object during panning-shot.

The IBIS does not have to shift the image sensor by the calculated adjustment shift amount (to the target position). The IBIS may shift the image sensor so that the position of the object image moves by a predetermined amount in a direction (predetermined direction) that approaches a position that is desired in terms of composition, such as the center position of the imaging screen, in a direction instructed by the photographer, or in a direction according to the object identification result.

### Second Embodiment

A description will now be given of a second embodiment. The first embodiment performs the composition adjustment by IBIS before exposure, then maintains the position of the object image whose composition has been adjusted during exposure, and performs object tracking using OIS. On the other hand, the second embodiment performs object tracking using cooperative control of OIS and IBIS during exposure.

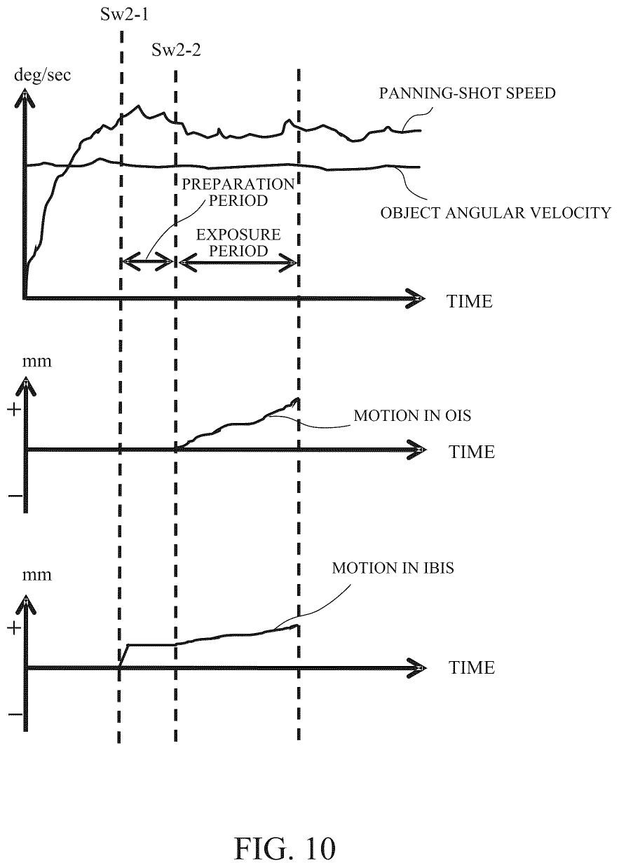

FIG. 10 adds IBIS shift during composition adjustment and cooperative control of OIS and IBIS to FIG. 5.

Good object tracking can be performed by properly setting a ratio at which each of them is responsible for object tracking (OIS correction ratio and IBIS correction ratio) based on the respective drivable amounts of OIS and IBIS in simultaneously controlling OIS and IBIS. The OIS+ correction ratio and OIS− correction ratio, which are OIS correction ratios according to the OIS shift direction (positive side and negative side), and the IBIS+ correction ratio and IBIS− correction ratio, which are IBIS correction ratios according to the IBIS shift direction (positive side and negative side), are calculated as follows: θOIS+ and θOIS− are the shift drivable amounts on the + and − sides of OIS, respectively. θIBIS+ and θIBIS− are the shift drivable amounts on the + and − sides of IBIS, respectively.

$$O I S + correction ratio : θ O I S \text{+/} \{ ( θ I B I S \text{+)} + ( θ O I S \text{+)} \} \\ O I S - correction ratio : θ O I S \text{-/} \{ ( θ I B I S \text{-)} + ( θ O I S \text{-)} \} \\ I B I S + correction ratio : θ I B I S \text{+/} \{ ( θ I B I S \text{+)} + ( θ O I S \text{+)} \} \\ I B I S - correction ratio : θ I B I S \text{-/} \{ ( θ I B I S \text{-)} + ( θ O I S \text{-)} \}$$

IBIS is performed for the composition adjustment during the preparation period that starts when Sw2-1 is turned on, and then cooperative control of OIS and IBIS is performed for object tracking using the above correction ratios during the exposure period that starts when Sw2-2. At this time, the IBIS is controlled from the shift position after the composition adjustment.

Thereby, the drivable amounts of OIS and IBIS can be effectively utilized for object tracking that supports a larger error between the object speed and the panning-shot speed.

As described above, each embodiment can perform a panning-shot image with a composition more desired by the user by adjusting the composition before exposure for object tracking.

While each embodiment performs the composition adjustment using IBIS, but may perform the composition adjustment using OIS, or both IBIS and OIS. In other words, the composition adjustment may be performed using at least one of IBIS and OIS. The lens MPU in the lens apparatus (optical apparatus) may serve as the above control apparatus.

Each embodiment has described a lens interchangeable type image pickup apparatus having the IBIS function to which an interchangeable lens equipped with an OIS is attached, but is applicable to a lens integrated type image pickup apparatus having the OIS and IBIS functions.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can perform a composition adjustment during panning-shot and then perform object tracking.

This application claims priority to Japanese Patent Application No. 2023-192682, which was filed on Nov. 13, 2023, and which is hereby incorporated by reference herein in its entirety.

What is claimed is:

1. A control apparatus comprising:
a processor configured to:
acquire an object position and an object speed from an image generated using an output of an image sensor that is configured to photoelectrically convert an object image formed by an optical system including an optical element,
perform a first control that moves at least one of the optical element and the image sensor based on the object speed and a detection result of a motion of an optical apparatus including at least one of the optical system and the image sensor by panning-shot the optical apparatus, and
perform a second control that moves the at least one of the optical element and the image sensor based on the object position before the imaging so that the object image moves to a predetermined position or direction on the image sensor.

2. The control apparatus according to claim 1, wherein the processor is configured to:
move one of the optical element and the image sensor in the second control, and
stop, in the first control, the one of the optical element and the image sensor at a position moved in the second control and move the other of the optical element and the image sensor.

3. The control apparatus according to claim 1, wherein the processor is configured to move, in the first control, the optical element and the image sensor according to a ratio calculated based on respective drivable amounts of the optical element and the image sensor.

4. The control apparatus according to claim 1, wherein the processor is configured to:
perform the second control in a first period from when a start of the imaging is instructed to when the imaging starts, and
performs the first control in a second period after the imaging starts.

5. The control apparatus according to claim 1, wherein the predetermined position or direction is a center position of the image sensor or a direction approaching the center position.

6. The control apparatus according to claim 1, wherein the predetermined position or direction is a position or direction instructed by a user.

7. The control apparatus according to claim 1, wherein the predetermined position or direction is a position or direction according to an identification result of the moving object from the image.

8. An optical apparatus comprising:
the control apparatus according to claim 1; and
at least one of the optical system and the image sensor.

9. An image pickup apparatus comprising:
the control apparatus according to claim 1;
the image sensor; and
a driving unit configured to move the image sensor.

10. A lens apparatus detachably connected to the image pickup apparatus according to claim 9, the lens apparatus comprising:
the optical system; and
a driving unit configured to move the optical element.

11. A control method comprising:
acquiring an object position and an object speed from an image generated using an output of an image sensor that is configured to photoelectrically convert an object image formed by an optical system including an optical element,
performing a first control that moves at least one of the optical element and the image sensor based on the object speed and a detection result of a motion of an optical apparatus including at least one of the optical system and the image sensor by panning-shot the optical apparatus, and
performing a second control that moves the at least one of the optical element and the image sensor based on the object position before the imaging so that the object image moves to a predetermined position or direction on the image sensor.

12. A non-transitory computer-readable storage medium storing a program that causes a computer to execute a control method, the method comprising:
acquiring an object position and an object speed from an image generated using an output of an image sensor that is configured to photoelectrically convert an object image formed by an optical system including an optical element,
performing a first control that moves at least one of the optical element and the image sensor based on the object speed and a detection result of a motion of an optical apparatus including at least one of the optical system and the image sensor by panning-shot the optical apparatus, and
performing a second control that moves the at least one of the optical element and the image sensor based on the object position before the imaging so that the object image moves to a predetermined position or direction on the image sensor.
